(19) United States
(12) Patent Application Publication
(10) Pub. No.: US 2004/0100581 A1
(43) Pub. Date: May 27, 2004

(54) System and method for inserting live video into pre-produced video

(75) Inventor: Brown Williams, Princeton, NJ (US)

Correspondence Address: STERNE, KESSLER, GOLDSTEIN & FOX PLLC, 1100 NEW YORK AVENUE, N.W., WASHINGTON, DC, 20005, US

(73) Assignee: Princeton Video Image, Inc.

(21) Appl. No.: 10/304,695

(22) Filed: Nov. 27, 2002

(51) Int. Cl. H04N 7/08; H04N 7/087

(52) U.S. Cl. 348/473; 348/584

(57) ABSTRACT

A method for inserting live video broadcast into a pre-produced video is provided. A pre-produced video is first stored. An insertion point in the pre-produced video is then identified and stored. Next, a video clip from a live broadcast is saved. The video clip is then combined with the pre-produced video via the insertion point. Finally, the result of the combination is displayed. Alternatively, a feed of the live video broadcast is directly combined with the pre-produced video without having to perform the step of recording the live event.

### BACKGROUND OF THE INVENTION

1. Field of the Invention

The present invention is generally related to video images, and more particularly to the insertion of live broadcast video into pre-recorded video.

2. Background Art

Electronic devices, such as described in U.S. Pat. No. 5,264,933, by Rosser et al., have been developed for inserting static advertising images into live broadcast video, such as that of sports events. For example, an operator may select portions of a displayed broadcast video in which to insert a static image such as an advertisement logo. An image synthesizer can then be employed to position the advertisement logo so that it appears as part of the original broadcasted scene. Such a system is a Live Video Insertion System (LVIS) available from Princeton Video Image, Inc., which is located in Princeton, N.J.

Inserting a static image into live broadcast video offers significant benefits to the advertiser. Such a technique, however, lacks the benefits of inserting a live video broadcast into a pre-produced video.

### BRIEF SUMMARY OF THE INVENTION

The present invention provides a system and method of inserting a live video broadcast into a pre-produced video, such as a commercial video. A pre-produced video is first stored. Next, an insertion point in the pre-produced video is identified and saved. The insertion point can be located by a number of different methods, including storing pixel locations for each frame in the video or using chroma-key technology. Next, a video clip of a live event is stored (e.g., a sporting event). Then, either during display of the pre-produced video, or immediately proceeding display of the pre-produced video, the video clip is combined with the pre-produced video via the insertion point. Finally, the result of the combination is displayed. Thus, an event that just occurred (e.g., a great catch from a football game) as part of a live TV show (e.g., a sports show, game show, or other live event) becomes part of a commercial a viewer is watching subsequent to the event taking place. In a further embodiment, a feed of a live video broadcast is directly mixed with the pre-produced video without having to perform the step of recording the live event.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention.

FIG. 1 is a flow chart of a method for inserting live broadcast video into an image, such as a pre-produced video image, in accordance with an embodiment of the present invention.

FIG. 2 is a flow chart of a method for inserting live broadcast video into an image, such as a pre-produced video image, in accordance with an alternate embodiment of the present invention.

FIG. 3 depicts an example computer system for implementing aspects of the present invention.

The features and advantages of the present invention will become more apparent from the detailed description set forth below when taken in conjunction with the drawings in which like reference characters identify corresponding elements throughout. In the drawings, like reference numbers generally indicate identical, functionally similar, and/or structurally similar elements. The drawings in which an element first appears is indicated by the leftmost digit(s) in the corresponding reference number.

### DETAILED DESCRIPTION OF THE INVENTION

While the present invention is described herein with reference to a specific example, it should be understood that the invention is not limited thereto. Those skilled in the art with access to the teachings provided herein will recognize that embodiments of the present invention may be practiced in a wide variety of applications.

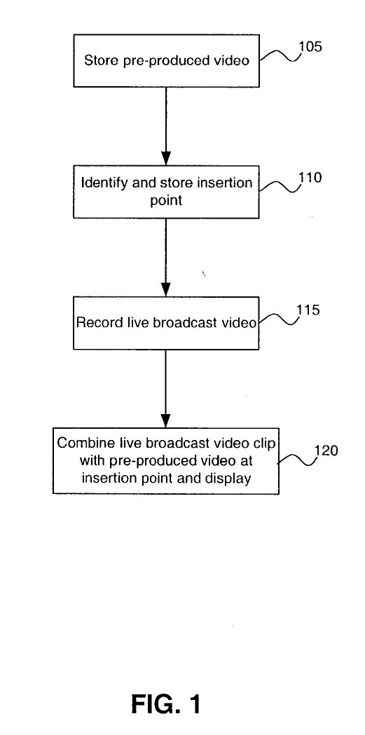

FIG. 1 is a flow chart of a method 100 for inserting live broadcast video into an image such as a pre-produced video image in accordance with an embodiment of the present invention. The invention, however, is not limited to the description provided by the flowchart 100. Rather, it will be apparent to persons skilled in the art from the teachings provided herein that other functional flows are within the scope and spirit of the present invention.

In step 105, a pre-produced (e.g., pre-recorded) video image is stored. As will be appreciated by persons skilled in the relevant art(s), the pre-produced video image may be stored on any known form of electronic storage media for eventual playback (i.e., execution of a series of video frames). The pre-produced video image may comprise, for example, a commercial advertisement depicting two people sitting in front of a television set.

In step 110, an insertion point in the pre-produced video is identified. The insertion point is the point at which the live broadcast video is inserted into the pre-produced video image. The insertion point can be identified in a variety of ways. In one embodiment, a set of pixel locations defining an insertion point for each frame in the pre-produced video are saved. With further reference to the example above, the insertion point could coincide with the location of the television screen in the pre-produced video.

As will be appreciated by persons skilled in the relevant art(s), video images are composed of pixels. Thus, after determining the precise location at which the live broadcast video will be inserted into the pre-produced video image, an embodiment of the present invention saves the pixel coordinates defining the insertion point before the insertion occurs. Furthermore, in combining the pre-produced video image with other video images, such as a series of frames, it may be necessary to define the insertion point at different coordinates in each frame. Thus, to accommodate this possibility, an embodiment of the present invention stores a set of pixel coordinates for each frame, such that the insertion point of the live broadcast video is allowed to constantly “move” within the pre-produced video image.

In another embodiment, a “chromo-key” technique for merging video images can also be employed to achieve the insertion. This is typically done by filming the insertion point as a certain color (e.g., blue). Thus the video can be inserted into the blue area of the pre-produced video.

In step 115, a live broadcast video is recorded. Again, with further reference to the example above, the broadcast video may include a live sports event such as a football game. A discrete video clip from the broadcast (e.g., a great catch, a touchdown, a home-run, etc.) is selected for further processing and insertion into the pre-produced video.

In step 120, the video clip and the pre-produced video are combined and displayed for viewing. The step of combining can be performed prior to broadcasting the pre-produced video or in real-time during display of the pre-produced video. Thus, an embodiment of the present invention allows an event that just occurred moments before to appear as if it is being transmitted via the insertion point in the pre-produced video. For example, a touchdown is scored during a football game watched by a viewer. Shortly thereafter, an embodiment of the present invention allows a commercial to be aired that shows characters reacting to the same touchdown seen by the viewer only moments before. This reality-based advertising provides the advantage of allowing the commercial to appear “fresh” each time it is aired, thereby causing viewers to remain interested in the commercial.

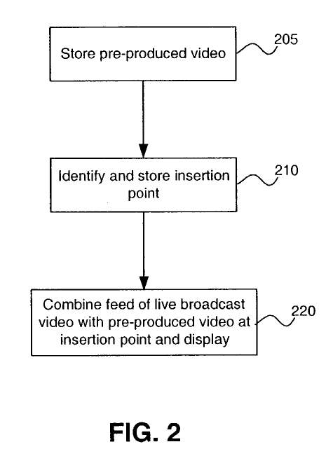

In a further embodiment of the present invention, step 115 of recording the live broadcast video 115 is omitted and a feed of the live broadcast video is inserted directly into the pre-produced video. Such an embodiment is depicted in the flowchart 200 of FIG. 2. As shown in FIG. 2, at step 205 a pre-produced video image is stored and at step 210 an insertion point into the pre-produced video image is identified and stored. Steps 205 and step 210 are substantially similar to steps 105 and 100 described above in reference to flowchart 100 of FIG. 1. At step 215, a live video feed (regardless of whether or not it is recorded) is inserted directly into the pre-produced video image at the insertion point that was identified and stored in step 210. This alternate embodiment permits pre-produced video images to be “wrapped around” a live video broadcast as the live event is actually occurring. For example, a live video broadcast of a football game may be inserted into a pre-recorded commercial advertisement depicting two people sitting in front of a television set, wherein the display area of the television set is the insertion point, and wherein the inserted video is a feed of live broadcast event actually occurring when the commercial is aired.

### EXAMPLE COMPUTER IMPLEMENTATION

In accordance with various embodiments of the present invention, aspects of the above-described method for inserting a live video image in a pre-produced video image may be implemented using hardware, software or a combination thereof and may be implemented in one or more computer systems or other processing systems.

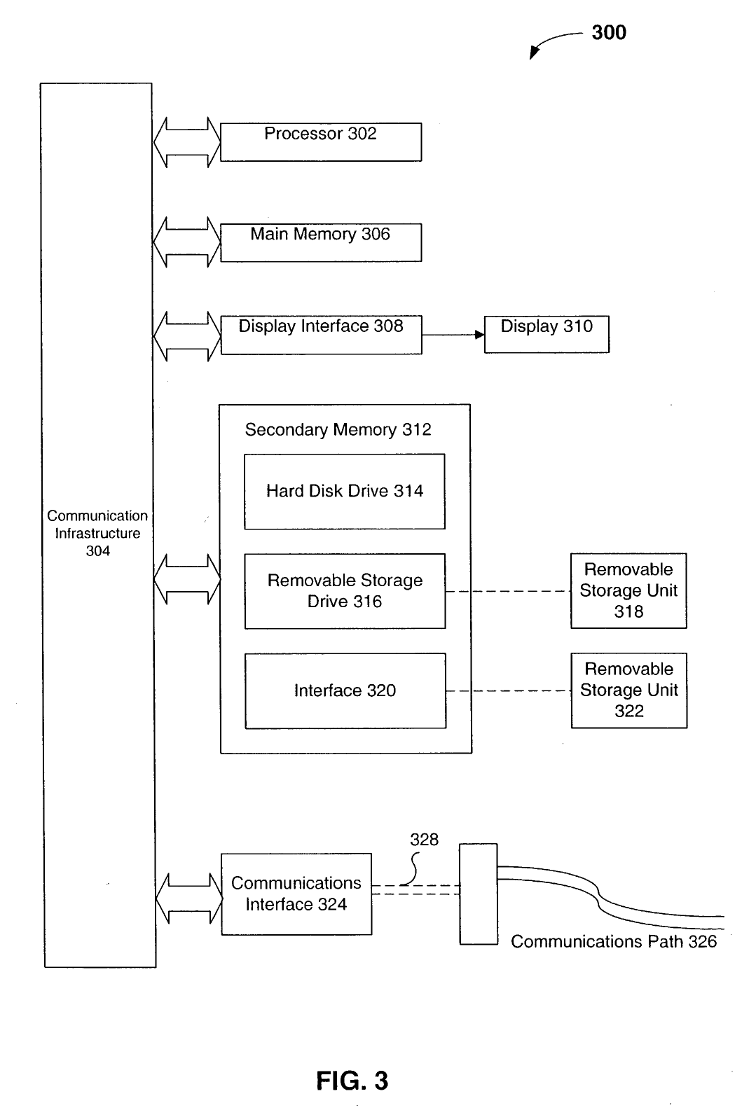

An example of a computer system 300 that may implement aspects of the present invention is shown in FIG. 3. For example, various method steps for inserting a live video image in a pre-produced video image as described herein may be implemented in software running on a computer system such as example computer system 300. In an embodiment, a camera and/or other broadcast equipment is connected to example computer system 300 to facilitate execution of such method steps.

Example computer system 300 includes one or more processors, such as processor 302, that can execute software that implements any of the above-described method steps. As shown in FIG. 3, each processor 302 is connected to a communication infrastructure 304 (e.g., a communications bus, cross-bar, or network). Example computer system 300 also includes a display interface 308 that forwards graphics, text, and other data from the communication infrastructure 304 (or from a frame buffer, not shown) for display on a display unit 310.

Example computer system 300 also includes a main memory 306, preferably random access memory (RAM), and may also include a secondary memory 312. Secondary memory 312 may include, for example, a hard disk drive 314 and/or a removable storage drive 316, representing a floppy disk drive, a magnetic tape drive, an optical disk drive, etc. Removable storage drive 316 reads from and/or writes to a removable storage unit 318 in a well known manner. Removable storage unit 318 represents a floppy disk, magnetic tape, optical disk, or the like, which is read by and written to by removable storage drive 316. As will be appreciated by persons skilled in the relevant art(s), removable storage unit 318 includes a computer usable storage medium having stored therein computer software and/or data.

In an alternative embodiment, secondary memory 312 may include other similar means for allowing computer programs or other instructions to be loaded into example computer system 300. Such means can include, for example, a removable storage unit 322 and a corresponding interface 320. Examples of removable storage unit 322 and interface 320 include a program cartridge and cartridge interface such as that found in video game console devices, a removable memory chip, such as an EPROM or PROM, and associated socket, or any other removable storage unit 322 and interface 320 that allow software and data to be transferred from removable storage unit 322 to example computer system 300.

Example computer system 300 may also include a communications interface 324. Communications interface 324 allows software and data to be transferred between example computer system 300 and one or more external devices via a communications path 326. Examples of communications interface 324 include, but are not limited to, a digital or analog modem, a network interface such as an Ethernet card, or a communications port such as a serial or parallel port. Software and data transferred via communications interface 324 are in the form of signals 328 which can be electronic, electromagnetic, optical, or some other form capable of being received by communications interface 324 via communications path 326. Note that communications interface 324 provides a means by which example computer system 300 can interface to a network such as the Internet.

Aspects of the present invention may be implemented in software that is stored as a computer program product and executed by example computer system 300. As used herein, the term “computer program product” is used to generally refer to removable storage unit 318, removable storage unit 322, a hard disk installed in hard disk drive 314, or a carrier wave carrying software over communication path 326 (wireless link or cable) to communication interface 324. A computer useable medium may include magnetic media, optical media, or other recordable media, or media that transmits a carrier wave or other signal. Such computer program products comprise means for providing software to example computer system 300.

Computer programs (also called computer control logic) are stored in main memory 306 and/or secondary memory 312. Computer programs can also be received via communications interface 324. Such computer programs, when executed, enable example computer system 300 to perform aspects of the present invention as discussed elsewhere herein.

In an alternate embodiment, aspects of the present invention are implemented primarily in firmware and/or hardware using, for example, hardware components such as application specific integrated circuits (ASICs). Implementation of a hardware state machine so as to perform functions described herein will be apparent to persons skilled in the relevant art(s).

### CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the invention. Thus, the present invention should not be limited by any of the above-described exemplary embodiments, but should be defined only in accordance with the following claims and their equivalents.

What is claimed is:

1. A method of inserting live video into pre-produced video, comprising:
storing a pre-produced video image;
identifying an insertion point in said pre-produced video image;
recording a live event to produce a live video clip;
inserting said live video clip into said pre-produced video image at said insertion point to generate a combined video image; and
displaying said combined video image.

2. The method of claim 1, further comprising the step of storing said insertion point prior to said combining said pre-produced video image with said live video clip.

3. The method of claim 1, wherein said storing a pre-produced video image comprises storing a series of frames, and wherein said identifying an insertion point in said pre-produced video image comprises identifying a set of pixel values for each frame in said series of frames.

4. The method of claim 3, wherein said inserting said live video clip into said pre-produced video image at said insertion point comprises inserting said live video clip into each frame in said series of frames at the set of pixel values identified for each frame in said series of frames.

5. The method of claim 1, wherein said inserting said live video clip into said pre-produced video image at said insertion point comprises applying a chromo-key technique.

6. A method of inserting live video into pre-produced video, comprising:
storing a pre-produced video image;
identifying an insertion point in said pre-produced video image;
inserting a live video feed into said pre-produced video image at said insertion point to generate a combined video image; and
displaying said combined video image.

7. The method of claim 6, further comprising the step of storing said insertion point prior to said combining said pre-produced video image with said live video feed.

8. The method of claim 6, wherein said storing a pre-produced video image comprises storing a series of frames, and wherein said identifying an insertion point in said pre-produced video image comprises identifying a set of pixel values for each frame in said series of frames.

9. The method of claim 8, wherein said inserting said live video feed into said pre-produced video image at said insertion point comprises inserting said live video feed into each frame in said series of frames at the set of pixel values identified for each frame in said series of frames.

10. The method of claim 6, wherein said inserting said live video feed into said pre-produced video image at said insertion point comprises applying a chromo-key technique.
